(19) United States
(12) Patent Application Publication
(10) Pub. No.: US 2015/0367683 A1
(43) Pub. Date: Dec. 24, 2015

(54) Quick Assembly Bicycle Inner Tube

(71) Applicant: Shanghai TianMa Vancom Rubber Products Co., Ltd., Shanghai (CN)

(72) Inventors: Quan Ming Zhao, Shanghai (CN); Xue Yun Yang, Shanghai (CN)

(21) Appl. No.: 14/491,883

(22) Filed: Sep. 19, 2014

(30) Foreign Application Priority Data
Jun. 19, 2014 (CN) 201420326609.3

(51) Int. Cl. B60C 5/10; B23P 6/00

(52) U.S. Cl. CPC B60C 5/10; B23P 6/00

(57) ABSTRACT

A quick assembly bicycle inner tube comprising a cylindrical hollow body strip with two distal ends, an air valve, and end coverings formed of round cup shaped bodies, each end covering integral to a distal end of the tube. Each end covering has a closed head, where a first end covering is formed with a protrusion or convex head; and a second end covering is formed with a matching recess or concave head. When inflated in a tire, the protrusion at the first distal end sits flush against the recess of the second distal end. The bicycle inner tube and method of installing the inner tube, eliminates the need for tools to disassemble the wheel set, allowing the user to manually remove and replace the inner tube without removing the wheel set from the bicycle. The inner tube is further easily folded into a flat shape to facilitate easy portability.

### CROSS-REFERENCE TO RELATED APPLICATION

This application claims priority to China application no. 201420326609.3 filed on Jun. 19, 2014, which is hereby incorporated by reference in its entirety.

### BACKGROUND OF THE INVENTION

1. Field of the Invention

The present invention relates to bicycle inner tubes. More particularly, the invention relates to the quick assembly of pneumatic bicycle inner tubes without disassembling the bicycle wheel set.

2. Background

In existing bicycle pneumatic inner tubes, the traditional bicycle pneumatic tire is composed of a pneumatic tire and a contiguously round inner tube which is embedded inside the tire, and the tire is installed on a wheel set of the bicycle. The typical inner tube is ring shaped to fit inside the pneumatic tire, and filled with compressed air. The wheel set is installed in the bicycle fork and the rear dropout frame, making it necessary to use tools or the help of professionals to disassemble the wheel set and also remove the tire and inner tube in order to fix air leaks in the inner tube. Due to the need for tools, if you are already out on a ride, even if you are carrying a spare inner tube, it is impracticable, time consuming, costly and inconvenient to independently replace or fix the traditional round inner tube.

Accordingly, there is a need for manually fixing and changing an inner tube without disassembling the bicycle wheel set.

### SUMMARY OF THE INVENTION

The objective of the present invention is to provide a bicycle inner tube strip, with a simple manual repair or replacement process that does not require the use of tools or disassembly of the wheel sets. The purpose of the invention is to overcome the inconveniences which are apparent from fixing or changing a traditional pneumatic round/ring-shaped inner tube. When inflated inside a pneumatic tire, the separately closed ends of the quick assembly bicycle inner tube according to the present invention will come into contact, and function similarly to a traditional round inner tube.

According to an embodiment of the present invention, a quick assembly bicycle inner tube is provided, which comprises an elongated flexible inner tube body having two distal ends and a valve installed on the inner tube body. The body of the inner tube is hollow and comprises a long cylindrical tube strip with covered ends on both ends of the tube. The tube strip having distinct disconnected ends is thereby not formed as a contiguous ring. The main body is cylindrical, which comprises at each end of the body, a cylindrical (round cup-shaped) end covering. At one cylindrical end covering is a recess/sink hole or a concave configured head which is recessed into the inner tube along its longitudinal axis. At the other cylindrical end covering is a protrusion or convex configured head which protrudes outward from the inner tube along its longitudinal axis, so as to fit the shape of the recess/concave configured head when the end coverings meet in the inflated state within a tire.

The recessed end covering has an annular outermost diameter which forms the cup-shaped end having an essentially flat ring-like flanged face with a recessed sink hole through the center of the inner tube. The annular outermost diameter is the same diameter as the outer diameter of the elongated inner tube body. The protruding end covering has an annular outermost diameter which forms the cup-shaped end having an essentially flat ring-like flanged face with a protruding portion protruding from the center of the inner tube. The annular outermost diameter of the protruding end covering is also the same diameter as the outer diameter of the elongated inner tube body, so as to form a seamless tube. When installed, the inner tube end coverings will be facing each other, and as the tube is inflated the protrusion at the protruding end covering will stretch to match fit tightly into the sink hole at the recessed end covering, where the ring-like flanged faces will be flush against each other to form a tight, essentially seamless contact. The materials used for the end coverings and the inner tube are of homogeneous materials.

When in use inside a tire and set in the wheel of a bicycle, the outer faces of the end coverings will be opposite each other and interconnect together (with the convex head protruding into the sink hole of the concave head) to essentially form the shape of a traditional round inner tube. When the tube is inflated inside the tire, the end coverings of the inner tube will connect tightly, seamlessly and smoothly. The inner tube will therefore function as the equivalent of a traditional contiguously formed inner tube. When the tube needs to be replace or repaired, there is no special tools required to disassemble the entire wheel assembly, no required operating environment is needed to replace the tire, the tire need not be dismantled/peeled off from the wheel as only the inner tube can be pulled out from the tire as it will have two separate ends. The inner tube can then be repaired and/or replaced very easily and conveniently, saving time and effort and the separate end configuration further facilitates portability of the deflated tube since it can be easily folded or wound up.

Embodiments of the present invention have the following advantageous effects: there is no longer a need to use tools to remove the tire and inner tube. Instead, the inner tube of the present invention can be easily removed manually to save time and energy. When the quick assembly bicycle inner tube is deflated, it becomes collapsible, flat, foldable, and easy to carry. The overall structure is simple, easy to use, flexible, mobile, and universally interchangeable with existing ordinary inflatable tires, and therefore economical and practical. The present invention is an ideal replacement to existing ordinary inflatable bicycle inner tubes.

According to an embodiment of the present invention, there is a method of installing a bicycle inner tube formed of a hollow strip body with two distal ends with end caps, one end cap with a protrusion and the other with a recess. The method comprises forming an opening between the bicycle tire and a wheel rim of the bicycle, while the wheel is engaged in a fork or a dropout frame of the bicycle; inserting one distal end of the inner tube in the opening and inserting the valve of the inner tube through a valve hole on the wheel rim, then guiding the inner tube through the opening while rotating; and inflating the inner tube until the distal ends come into close contact by way of the protrusion matching the recess, forming a ring.

These and other embodiments of the present invention are further made apparent, in the remainder of the present document, to those of ordinary skill in the art.

### BRIEF DESCRIPTION OF THE DRAWINGS

In order to more fully describe embodiments of the present invention, reference is made to the accompanying drawings. These drawings are not to be considered limitations in the scope of the invention, but are merely illustrative.

FIG. 1 is a structural diagram of a side view of the quick assembly bicycle inner tube, according to an embodiment of the present invention.

FIG. 2 is a cross-sectional diagram of the convex/protruding covered head portion of the bicycle tube, according to an embodiment of the present invention.

FIG. 3 is a cross-sectional diagram of the concave/recessed head portion of the bicycle tube, according to an embodiment of the present invention.

FIG. 4 is a general diagram illustrating the assembly of the quick assembly bicycle inner tube onto a tire, according to an embodiment of the present invention.

FIG. 5 shows the assembly of the inner tube by first positioning the valve through the valve hole in the bicycle wheel, according to an embodiment of the present invention.

### DETAILED DESCRIPTION OF SPECIFIC EMBODIMENTS

The description above and below and the drawings of the present document focus on one or more currently preferred embodiments of the present invention and also describe some exemplary optional features and/or alternative embodiments. The description and drawings are for the purpose of illustration and not limitation. Those of ordinary skill in the art would recognize variations, modifications, and alternatives. Such variations, modifications, and alternatives are also within the scope of the present invention.

The quick assembly bicycle inner tube according to embodiments of the present invention will be further described in detail with reference to the accompanying drawings in the following description.

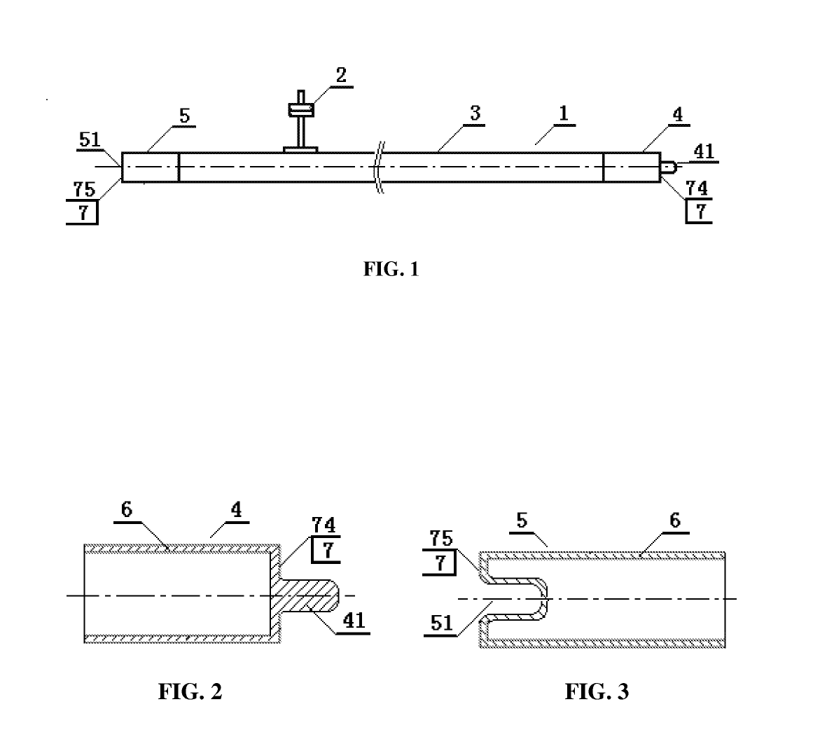

As shown in FIGS. 1 to 4, a quick assembly bicycle inner tube according to an embodiment of the present invention comprises a cylindrical rubber tube 1 having a hollow body 3, a valve 2, end coverings 4, 5 with round cup body surfaces 6, and closed end caps 7. The quick assembly bicycle inner tube comprising cylindrical tube 1 includes the valve 2 which is installed on the inner tube. The inner tube has two end coverings 4, 5 each of which is installed on both ends of the tube. The end coverings 4, 5 are made of the same material as the hollow body 3. The main body is cylindrical and terminates at the two closed cupped body end caps 7 on each end of the tube. At a first end of the tube there is a convex end covering 4 and at a second end of the tube there is a concave end covering 5. The shape of the end coverings 4, 5 include an annular/round outer diameter along the body surface 6, and a cupped bottom face/end cap 7. The outermost diameter of the body surface 6 at each end covering 4, 5 is the same as the elongated hollow body 3 and seamlessly continues, and may be formed of the same material.

As shown in FIG. 2, the convex end covering 4 has an end cap 7 which is formed to have a protrusion 41 that protrudes from the flanged surface of the convex head 74. The flanged surface 74 is substantially a flat portion in the radial direction with respect to the length of the tube. As shown in FIG. 3, the concave end covering 5 has an end cap 7 which is formed to have a recess/sinkhole 51 that is recessed into the tube from the flanged surface of the concave head 75. The flanged surface 75 is substantially a flat portion in the radial direction with respect to the length of the tube.

The outermost diameter 6 of the end coverings 4, 5 can be joined with the hollow body 3. According to an embodiment, as shown in FIG. 1, the end covering 4, 5 material is fused to the material of the hollow body 3. The convex end covering 4 is connected to match fit the concave end covering 5 such that the protrusion 41 fits inside the recess 51 and the flanged surfaces 74 and 75 fit flush together when inflated.

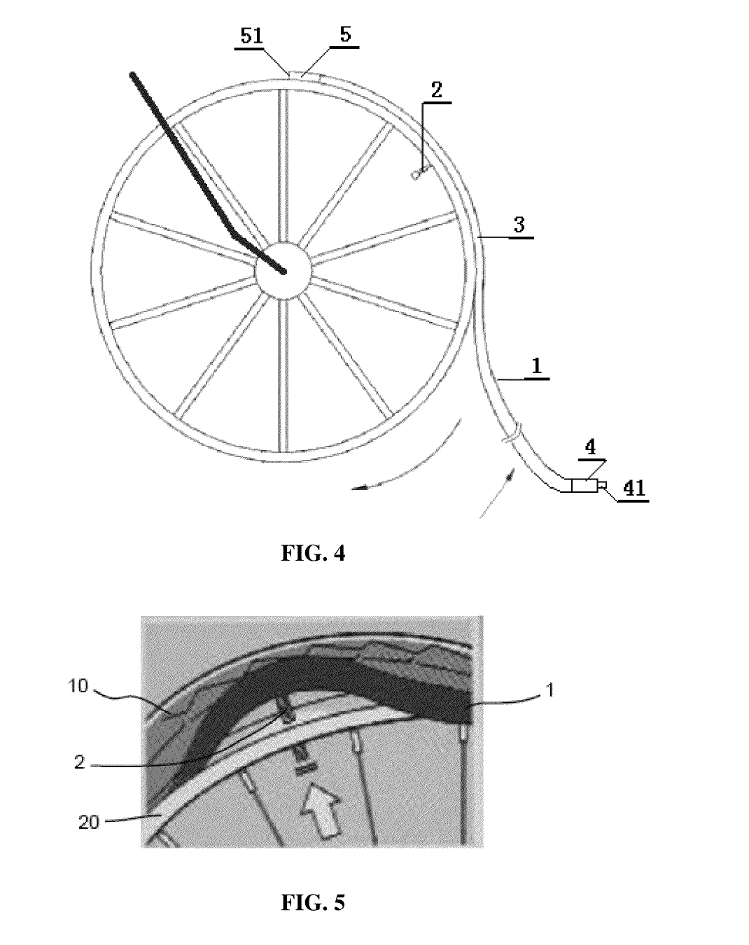

As shown in FIGS. 4 and 5, the inner tube of the present invention is replaced by removing the defective or flat inner tube by pushing the tire back from the rim of the wheel, for example by a tool to pry the tire away from the wheel rim, and pulling out one free end of the tube until the entire tube is pulled out. The defective tube can then be easily flattened, folded up and easily carried. If an existing conventional inner tube is in the tire, simply pull out some of the defective tube through the opening between the tire and wheel rim, cut the tube so that the defective tube can be slid out through the opening, without requiring any disassembly of the entire tire form the bicycle. The wheel set may stay intact and need not be disassembled in this process.

As shown in FIG. 5, to insert the new tube 1 into a tire 10, find the valve stem hole on the rim 20 of the wheel, pull back the tire 10 from the rim 20 and insert the free end of the tube where the valve stem 2 is closest to, and insert the valve stem 2 through the hole in the rim 20. The remainder of the inner tube strip is then guided into the tire 10 by pushing the tire 10 away from the rim 20 while rotating the tire 10 until all the inner tube 1 has been fully inserted and the distal ends with protrusion 41 and recess 51 are in contact. The wheel is rotated while still on the fork or dropout frame, therefore requiring no disassembly. For ease in inserting the new tube, pump some air into the tube so that it has some body to it which will facilitate insertion into the tire.

As air is pumped into the tube the closed distal ends coverings 4, 5 will press against each other closely to function as a traditional contiguously round inner tube.

Accordingly, to change or fix an inner tube of the present invention requires no tools to disassemble or remove the wheel set from the bicycle. Such process saves time and energy.

According to an embodiment of the present invention, the inner tube 1 and all components, except for the valve 2, is manufactured of the same rubber material. The inner tubes are manufactured to match the size and design of a traditional inner tube specification such that it meets the specifications of tires. In the manufacturing method according to the present invention, the raw rubber material for the inner is cut to a specified length and size and made in the form of a hollow strip body. The end coverings are connected to the hollow strip body and made of the same material as the hollow strip body.

According to an embodiment of the manufacturing method, as shown in FIG. 1, the round end coverings 4, 5 material is fused to the material of the hollow body 3. In particular, the outermost diameter of each of the separately formed end coverings 4, 5 is joined with the hollow body 3. The raw material inner tube is put into a vulcanized can at 150 to 160 degrees C. for approximately 1 to 1.5 hours for strength and flexibility.

According to an embodiment of the present invention, there is a method of installing a bicycle inner tube formed of a hollow strip body with two distal ends with end caps. The method comprises prying a bicycle tire away from a wheel rim of the bicycle to form an opening, while the wheel is engaged in a fork or a dropout frame of the bicycle; inserting one distal end of the inner tube in the opening; inserting the valve through a valve hole on the wheel rim; guiding the inner tube through the opening while rotating the wheel; and inflating the inner tube until the distal ends come into close contact forming a ring. The installed inner tube therefore functions as a convention inner tube that is contiguously formed as ring since the distal ends press against each other to form the completed ring inside the tire.

Throughout the description and drawings, example embodiments are given with reference to specific configurations. It will be appreciated by those of ordinary skill in the art that the present invention can be embodied in other specific forms. Those of ordinary skill in the art would be able to practice such other embodiments without undue experimentation. The scope of the present invention, for the purpose of the present patent document, is not limited merely to the specific example embodiments of the foregoing description.

What is claimed is:

1. A quick assembly bicycle inner tube comprising:
a cylindrical hollow main body having disjoined distal ends;
a valve installed on the inner tube through the hollow main body;
a first cylindrical closed end cover and a second cylindrical closed end cover, the first closed end cover integral to a first distal end of the tube and the second closed end cover integral to a second distal end of the tube, wherein each of the cylindrical closed end covers are formed of the same material as the hollow main body;
a protrusion at the first cylindrical closed end cover that extends outward from the hollow main body; and
a recess at the second cylindrical closed end cover that sinks into the hollow main body.

2. The quick assembly bicycle inner tube of claim 1, wherein an outermost diameter of each of the cylindrical closed end covers is joined to align longitudinally with an outer diameter of each distal end of the hollow main body.

3. The quick assembly bicycle inner tube of claim 1, wherein a first face at the first cylindrical closed end cover which surrounds the protrusion and a second face at the second cylindrical closed end cover which surrounds the recess is substantially flat.

4. The quick assembly bicycle inner tube of claim 3, wherein the first face and the second face is flat in a radial direction that is perpendicular to a longitudinal direction of the hollow main body.

5. The quick assembly bicycle inner tube of claim 1, wherein each cylindrical closed end cover includes an end cap that is joined to an outer diameter of each end cover, wherein the protrusion is formed as an extension from a first end cap and the recess is formed to sink inward from the end cap.

6. The quick assembly bicycle inner tube of claim 1, wherein the inner tube has a length such that the protrusion at the first distal end fits against the recess at the second distal end to form a circle when the inner tube is inserted in a bicycle tire.

7. The quick assembly bicycle inner tube of claim 6, wherein a face surrounding the protrusion at the first closed end cover and a face surrounding the recess at the second closed end cover are flat.

8. The quick assembly bicycle inner tube of claim 1, wherein the valve is located on the inner tube at a distance closer to one distal end than the other distal end.

9. A method of installing a bicycle inner tube for a bicycle, the inner tube comprising: a cylindrical hollow main body having disjoined distal ends; a valve installed on the inner tube through the hollow main body; a pair of cylindrical end covers, each end cover installed on each distal end of the tube, wherein the end covers are formed of the same material as the hollow main body; and a closed end cap on each end cover at each distal end, wherein a first closed end cap includes a protrusion that extends outward from the hollow main body, and a second closed end cap includes a recess that sinks into the hollow main body; the method comprising:
prying a bicycle tire away from a wheel rim of the bicycle to form an opening, while the wheel is engaged in a fork or a dropout frame of the bicycle;
inserting one distal end of the inner tube in the opening;
inserting the valve through a valve hole on the wheel rim;
guiding the inner tube through the opening while rotating the wheel; and
inflating the inner tube until the distal ends come into close contact such that the protrusion fits inside the recess to form a ring.
